(19) United States
(12) Patent Application Publication
(10) Pub. No.: US 2015/0317573 A1
(43) Pub. Date: Nov. 5, 2015

(54) USER-RELEVANT STATISTICAL ANALYTICS USING BUSINESS INTELLIGENCE SEMANTIC MODELING

(71) Applicant: International Business Machines Corporation, Armonk, NY (US)

(72) Inventors: Martin Petitclerc, Saint-Nicolas (CA); Franciscus Jacobus Johannes van Ham, Geldrop (NL); Qing Wei, Ottawa (CA)

(21) Appl. No.: 14/630,407

(22) Filed: Feb. 24, 2015

Related U.S. Application Data
(63) Continuation of application No. 14/266,497, filed on Apr. 30, 2014.

(51) Int. Cl. G06Q 10/06; G06N 99/00

(52) U.S. Cl. CPC G06Q 10/063; G06Q 10/067; G06N 99/005

(57) ABSTRACT

Techniques are described for analyzing and presenting results from a statistical analysis of a selected subset of data processed with statistical analysis techniques together with information from a business intelligence (BI) semantic model. In one example, a method includes receiving an input defining a selected subset of data from a structured representation of a set of data. The method further includes selecting one or more business intelligence factors from a business intelligence model based at least in part on the selected subset of data. The method further includes performing a statistical analysis of the selected subset of data based at least in part on the selected one or more business intelligence factors. The method further includes generating an output representing the statistical analysis of the selected subset of data based at least in part on the selected one or more business intelligence factors.

This application is a continuation of U.S. application Ser. No. 14/266,497, filed Apr. 30, 2014 entitled USER-RELEVANT STATISTICAL ANALYTICS USING BUSINESS INTELLIGENCE SEMANTIC MODELING, the entire content of which is incorporated herein by reference.

### TECHNICAL FIELD

This disclosure relates to business intelligence systems.

### BACKGROUND

Enterprise software systems are typically sophisticated, large-scale systems that support many, e.g., hundreds or thousands, of concurrent users. Examples of enterprise software systems include financial planning systems, budget planning systems, order management systems, inventory management systems, sales force management systems, business intelligence tools, enterprise reporting tools, project and resource management systems, and other enterprise software systems.

Many enterprise performance management and business planning applications require a large base of users to enter data that the software then accumulates into higher level areas of responsibility in the organization. Moreover, once data has been entered, it must be retrieved to be utilized. The system may perform mathematical calculations on the data, combining data submitted by many users. Using the results of these calculations, the system may generate reports for review by higher management. Often, these complex systems make use of multidimensional data sources that organize and manipulate the tremendous volume of data using data structures referred to as data cubes. Each data cube, for example, includes a plurality of hierarchical dimensions having levels and members for storing the multidimensional data.

Business intelligence (BI) systems may be used to provide insights into such collections of enterprise data. In some cases, analysts with expert knowledge in statistical analysis may apply analytical techniques to raw data, and prepare BI reports for business users.

### SUMMARY

In general, examples disclosed herein are directed to techniques for analyzing and presenting results from a statistical analysis of a selected subset of data processed with statistical analysis techniques together with information from a business intelligence (BI) semantic model. In one example, a method for applying business intelligence concepts in a statistical analysis of data includes receiving an input defining a selected subset of data from a structured representation of a set of data. The method further includes selecting one or more business intelligence factors from a business intelligence model based at least in part on the selected subset of data. The method further includes performing a statistical analysis of the selected subset of data based at least in part on the selected one or more business intelligence factors. The method further includes generating an output representing the statistical analysis of the selected subset of data based at least in part on the selected one or more business intelligence factors.

In another example, a computer program product for applying business intelligence concepts in a statistical analysis of data includes a computer-readable storage medium having program code embodied therewith. The program code is executable by a computing device to receive an input defining a selected subset of data from a structured representation of a set of data. The program code is further executable by a computing device to select one or more business intelligence factors from a business intelligence model based at least in part on the selected subset of data. The program code is further executable by a computing device to perform a statistical analysis of the selected subset of data based at least in part on the selected one or more business intelligence factors. The program code is further executable by a computing device to generate an output representing the statistical analysis of the selected subset of data based at least in part on the selected one or more business intelligence factors.

In another example, a computer system for applying business intelligence concepts in a statistical analysis of data includes one or more processors, one or more computer-readable memories, and one or more computer-readable, tangible storage devices. The computer system further includes program instructions, stored on at least one of the one or more storage devices for execution by at least one of the one or more processors via at least one of the one or more memories, to receive an input defining a selected subset of data from a structured representation of a set of data. The computer system further includes program instructions, stored on at least one of the one or more storage devices for execution by at least one of the one or more processors via at least one of the one or more memories, to select one or more business intelligence factors from a business intelligence model based at least in part on the selected subset of data. The computer system further includes program instructions, stored on at least one of the one or more storage devices for execution by at least one of the one or more processors via at least one of the one or more memories, to perform a statistical analysis of the selected subset of data based at least in part on the selected one or more business intelligence factors. The computer system further includes program instructions, stored on at least one of the one or more storage devices for execution by at least one of the one or more processors via at least one of the one or more memories, to generate an output representing the statistical analysis of the selected subset of data based at least in part on the selected one or more business intelligence factors.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example enterprise having a computing environment in which users interact with an enterprise business intelligence system.

FIG. 2 is a block diagram illustrating in further detail portions of one example of a computing environment including an enterprise business intelligence (BI) system.

FIG. 3 shows a data visualization user interface (UI) implemented as a graph generated by a BI portal application to represent a set of data and enable user selection of a subset of data, in accordance with an example of this disclosure.

FIG. 4 is a conceptual block diagram of an example business intelligence (BI) software system for applying statistical analysis techniques to selected subsets of data in combination with information from a BI semantic model, in accordance with an example of this disclosure.

FIG. 5 shows a flowchart for a BI analytics tool to apply an example process for applying statistical analysis techniques to selected subsets of data in combination with information from a BI semantic model, in accordance with an example of this disclosure.

FIG. 6 is a block diagram of a computing device that may implement a BI analytics tool as part of a BI computing system.

### DETAILED DESCRIPTION

Various examples are disclosed herein for analyzing and presenting results from a statistical analysis of a selected subset of data processed with statistical analysis techniques together with information from a business intelligence (BI) semantic model. In various examples of this disclosure, a system may generate visualizations of data in a data visualization user interface that enables a user to select subsets of data for analysis by a BI analytics tool applying statistical analysis techniques to selected subsets of data in combination with information from a BI semantic model. The user selection of the subsets of data for analysis may take the form of any type of user interaction, trigger, exception highlight or rule, or any user input that may define or indicate a subset of data.

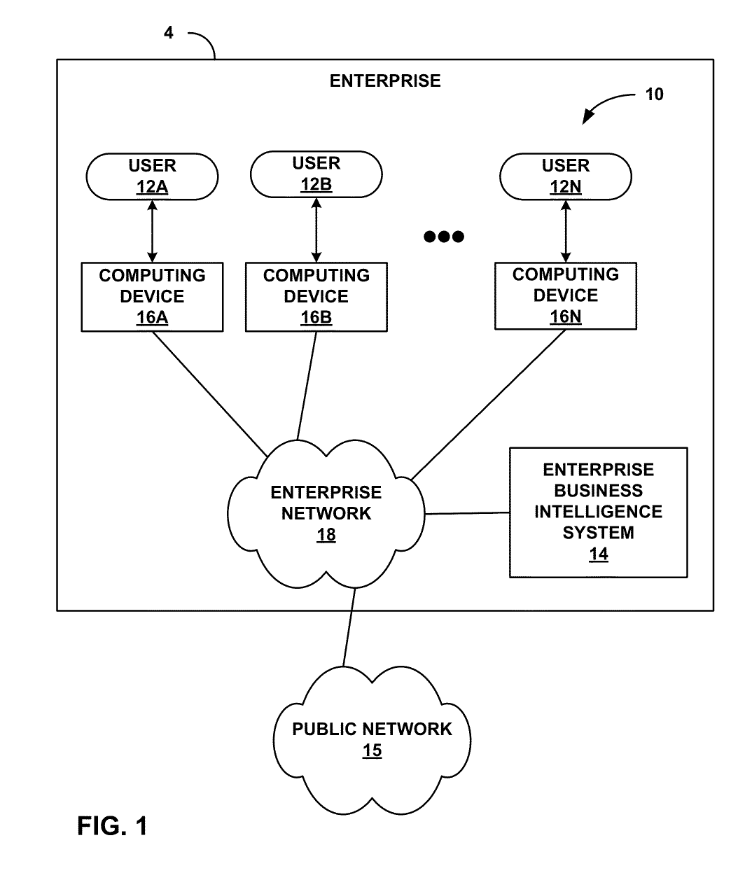

FIG. 1 is a block diagram illustrating an example enterprise 4 having a computing environment 10 in which a plurality of users 12A-12N (collectively, “users 12”) may interact with an enterprise business intelligence (BI) system 14. In the system shown in FIG. 1, enterprise business intelligence system 14 is communicatively coupled to a number of client computing devices 16A-16N (collectively, “client computing devices 16” or “computing devices 16”) by an enterprise network 18. Users 12 interact with their respective computing devices to access enterprise business intelligence system 14. Users 12, computing devices 16A-16N, enterprise network 18, and enterprise business intelligence system 14 may all be either in a single facility or widely dispersed in two or more separate locations anywhere in the world, in different examples.

For exemplary purposes, various examples of the techniques of this disclosure may be readily applied to various software systems, including enterprise business intelligence systems or other large-scale enterprise software systems. Examples of enterprise software systems include enterprise financial or budget planning systems, order management systems, inventory management systems, sales force management systems, business intelligence tools, enterprise reporting tools, project and resource management systems, and other enterprise software systems.

In this example, enterprise BI system 14 includes servers that run BI dashboard web applications and may provide business analytics software. A user 12 may use a BI portal on a client computing device 16 to view and manipulate information such as business intelligence reports (“BI reports”) and other collections and visualizations of data via their respective computing devices 16. This may include data from any of a wide variety of sources, including from multidimensional data structures and relational databases within enterprise 4, as well as data from a variety of external sources that may be accessible over public network 15.

Users 12 may use a variety of different types of computing devices 16 to interact with enterprise BI system 14 and access data visualization tools and other resources via enterprise network 18. For example, an enterprise user 12 may interact with enterprise BI system 14 and run a business intelligence (BI) portal (e.g., a BI dashboard) using a laptop computer, a desktop computer, or the like, which may run a web browser. Alternatively, an enterprise user may use a smartphone, tablet computer, or similar device, running a business intelligence dashboard in a web browser, a dedicated mobile application, or other means for interacting with enterprise business intelligence system 14.

BI system 14 may generate a structured representation of a set of data, and receive an input from enterprise user 12 defining a selected subset of data from the set of data. BI system 14 may select one or more business intelligence factors from a business intelligence model based at least in part on the selected subset of data. BI system 14 may then perform a statistical analysis of the selected subset of data based at least in part on the selected one or more business intelligence factors. BI system 14 may generate an output representing the statistical analysis of the selected subset of data based at least in part on the selected one or more business intelligence factors.

Enterprise network 18 and public network 15 may represent any communication network, and may include a packet-based digital network such as a private enterprise intranet or a public network like the Internet. In this manner, computing environment 10 can readily scale to suit large enterprises. Enterprise users 12 may directly access enterprise business intelligence system 14 via a local area network, or may remotely access enterprise business intelligence system 14 via a virtual private network, remote dial-up, or similar remote access communication mechanism.

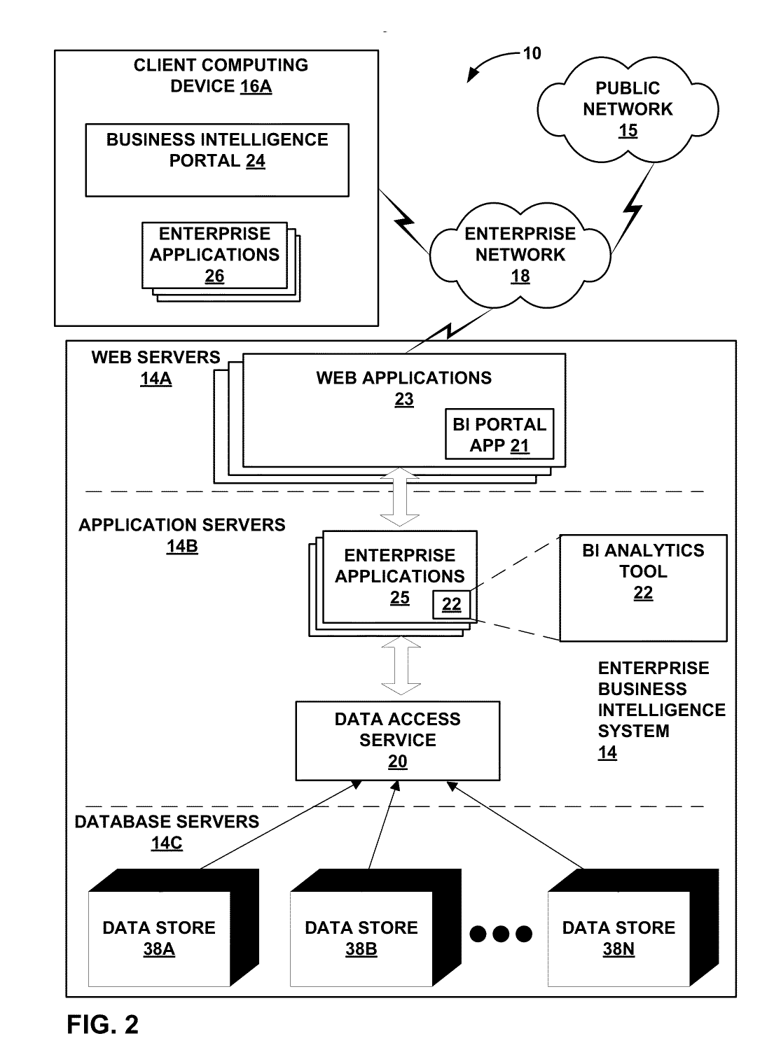

FIG. 2 is a block diagram illustrating in further detail portions of one example of computing environment 10 including an enterprise business intelligence (BI) system 14. In this example implementation, a single client computing device 16A is shown for purposes of example and includes a BI portal 24 and one or more client-side enterprise software applications 26 that may utilize and manipulate multidimensional data, including to view data visualizations and analytical tools with BI portal 24. BI portal 24 may be rendered within a general web browser application, within a locally hosted application or mobile application, or other user interface. BI portal 24 may be generated or rendered using any combination of application software and data local to the computing device it's being generated on, and/or remotely hosted in one or more application servers or other remote resources.

BI portal 24 may output data visualizations for a user to view and manipulate in accordance with various techniques described in further detail below. BI portal 24 may present data in the form of charts or graphs that a user may manipulate, for example. BI portal 24 may present visualizations of data based on data from sources such as a BI report, e.g., that may be generated with enterprise business intelligence system 14, or another BI dashboard, as well as other types of data sourced from external resources through public network 15. BI portal 24 may present visualizations of data based on data that may be sourced from within or external to the enterprise.

FIG. 2 depicts additional detail for enterprise business intelligence system 14 and how it may be accessed via interaction with a BI portal 24 for depicting and providing visualizations of business data, according to one or more examples. BI portal 24 may provide visualizations of data that represents, provides data from, or links to any of a variety of types of resource, such as a BI report, a software application, a database, a spreadsheet, a data structure, a flat file, Extensible Markup Language (“XML”) data, a comma separated values (CSV) file, a data stream, unorganized text or data, or other type of file or resource. BI portal 24 may also provide visualizations of data in a data visualization user interface that enables a business user to select subsets of data for analysis by a BI analytics tool 22 applying statistical analysis techniques to selected subsets of data in combination with information from a BI semantic model, for example.

BI analytics tool 22 may be hosted among enterprise applications 25, as in the example depicted in FIG. 2, or may be hosted elsewhere, including on a client computing device 16A, or distributed among various computing resources in enterprise business intelligence system 14, in some examples. BI analytics tool 22 may be implemented as or take the form of a stand-alone application, a portion or add-on of a larger application, a library of application code, a collection of multiple applications and/or portions of applications, or other forms, and may be executed by any one or more servers, client computing devices, processors or processing units, or other types of computing devices.

As depicted in FIG. 2, enterprise business intelligence system 14 is implemented in accordance with a three-tier architecture: (1) one or more web servers 14A that provide web applications 23 with user interface functions, including a server-side BI portal application 21; (2) one or more application servers 14B that provide an operating environment for enterprise software applications 25 and a data access service 20; and (3) data store servers 14C that provide one or more data stores 38A, 38B, . . . , 38N (“data stores 38”). Enterprise software applications 25 may include BI analytics tool 22 as one of enterprise software applications 25 or as a portion or portions of one or more of enterprise software applications 25. The data stores 38 may include two-dimensional databases and/or multidimensional databases or data cubes. The data sources may be implemented using a variety of vendor platforms, and may be distributed throughout the enterprise. As one example, the data stores 38 may be multidimensional databases configured for Online Analytical Processing (OLAP). As another example, the data stores 38 may be multidimensional databases configured to receive and execute Multidimensional Expression (MDX) queries of some arbitrary level of complexity. As yet another example, the data stores 38 may be two-dimensional relational databases configured to receive and execute SQL queries, also with an arbitrary level of complexity.

Multidimensional data structures are “multidimensional” in that each multidimensional data element is defined by a plurality of different object types, where each object is associated with a different dimension. The enterprise applications 26 on client computing device 16A may issue business queries to enterprise business intelligence system 14 to build reports. Enterprise business intelligence system 14 includes a data access service 20 that provides a logical interface to the data stores 38. Client computing device 16A may transmit query requests through enterprise network 18 to data access service 20. Data access service 20 may, for example, execute on the application servers intermediate to the enterprise software applications 25 and the underlying data sources in data store servers 14C. Data access service 20 retrieves a query result set from the underlying data sources, in accordance with query specifications. Data access service 20 may intercept or receive queries, e.g., by way of an API presented to enterprise applications 26. Data access service 20 may then return this result set to enterprise applications 26 as BI reports, other BI objects, and/or other sources of data that are made accessible to BI portal 24 on client computing device 16A. These may include sets of data that BI analytics tool 22 may present to a business user in a data visualization user interface in BI portal 24, enabling the business user to select subsets of the data for analysis in combination with information from a BI semantic model, as further described below. As described above and further below, BI analytics tool 22 may be implemented in one or more computing devices, and may involve one or more applications or other software modules that may be executed on one or more processors. Example embodiments of the present disclosure may illustratively be described in terms of the example of BI analytics tool 22 in various examples described below.

Generally, a business user may be interested by the characteristics of a targeted or selected subset of data from a data set. A regular business user may just be interested in the characteristics of that selected subset of data, not in a process or in statistical analysis techniques to get or to isolate the selected subset of data. A statistician may perform such data analysis manually using related mining and statistical technologies, which regular business users may not be able to do or interested in doing. BI analytics tool 22 may identify or perform one or more statistical analysis techniques to get or to isolate the selected subset of data. In one example, those analysis techniques may include a decision tree algorithm, and BI analytics tool 22 may apply a decision tree algorithm to the selected subset of data.

BI analytics tool 22 may generate a structured representation of a set of data in BI portal 24 on client computing device 16A, and receive an input from enterprise user 12 defining a selected subset of data from the set of data. BI analytics tool 22 may select one or more business intelligence factors from a business intelligence model based at least in part on the selected subset of data. BI analytics tool 22 may then perform a statistical analysis of the selected subset of data based at least in part on the selected one or more business intelligence factors. BI analytics tool 22 may generate an output representing the statistical analysis of the selected subset of data based at least in part on the selected one or more business intelligence factors.

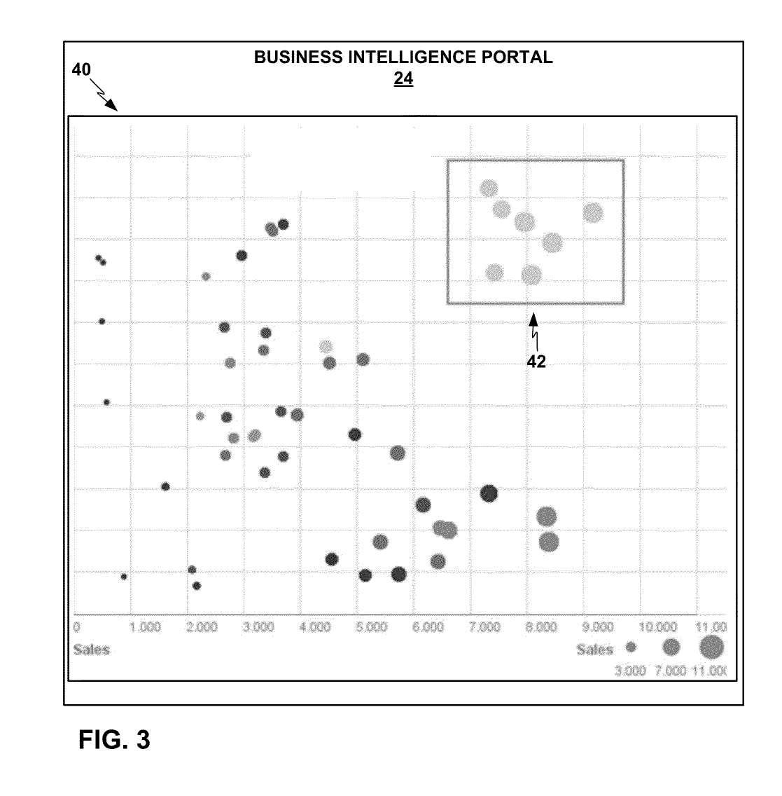

FIG. 3 shows a data visualization user interface (UI) 40 implemented as a graph 40 (i.e., UI 40 or graph 40) generated by BI portal application 21 to represent a set of data and enable user selection of a subset of data, in accordance with one example. In this example, BI portal application 21 may generate and provide, in data visualization UI 40, a structured representation of a set of data in the form of graph 40 that represents the set of data. For example, graph 40 may represent sales numbers for various sales transactions in a business district in one quarter, with each sales transaction plotted according to revenue along the x axis and profit margin along the y axis. A business user may select a subset of data 42 by entering a user input to select a portion of the data points (shown at 42) in the graph 40. BI analytics tool 22 may receive the input defining the selected subset of data 42 from the structured representation of the set of data, by receiving the user input via the user interface selecting the subset 42 of the graph 40. In other examples, BI portal application 21 and/or BI analytics tool 22 may provide a structured representation of the data set in the form of a chart, a grid, or any type of data visualization.

Statistical analytics process, such data mining, may typically use raw data input and produce raw results. They may typically require a user to prepare the data and extract the relevant information from the results, and may require the user to have advanced statistical analytics knowledge. In one example of this disclosure, BI analytics tool 22 may integrate a statistical analytics process with an interactive data selection mechanism as shown in FIG. 3, to enable an ordinary business user to select subsets of data to which to apply statistical analysis in combination with BI factors from a BI model, without requiring the business user to perform statistical analysis. BI analytics tool 22 may provide a data visualization user interface embedded directly in a BI application such as BI portal 24 that enables a user selection of data elements, then perform statistical analysis on the selected data elements, and process the results to display in the user interface. In this example, BI analytics tool 22 may perform data preparation, select statistical analytics techniques appropriate to the selected data, and filter, refine, and assemble the results of the analysis of the selected data. These functions performed by BI analytics tool 22 may be particularly helpful for isolating and understanding subsets of data that are distinguished from a main body of data by a combination of explanatory factors that emerge from very large amounts of data.

In one example of this disclosure, BI analytics tool 22 may apply a classification algorithm, such as a decision tree. BI analytics tool 22 may apply a decision tree classification algorithm that is trained on one set of already classified data. BI analytics tool 22 may use the decision tree classification algorithm to predict the classes of newly received or newly selected data items. BI analytics tool 22 may apply decision tree algorithms that can determine the factors that best distinguish a selected subset of a data set, relative to the rest of the dataset, or to some other portion of the data set. For example, BI analytics tool 22 may determine that a selected set of data items in a data visualization user interface all share a common property, by running a decision tree classification algorithm that classifies data items in the visualization into two sets: “data items that are in the selected set” and “data items that are not in the selected set.” BI analytics tool 22 may construct a decision tree, and then accept the top level nodes in the decision tree as indicating a factor or combination of factors that might best uniquely describe the selected subset of data items. BI analytics tool 22 may then communicate this factor or combination of factors to the user. BI analytics tool 22 may communicate this factor or combination of factors as rules that may indicate to the user the attributes and values that most accurately describe or characterize the selected subset of data.

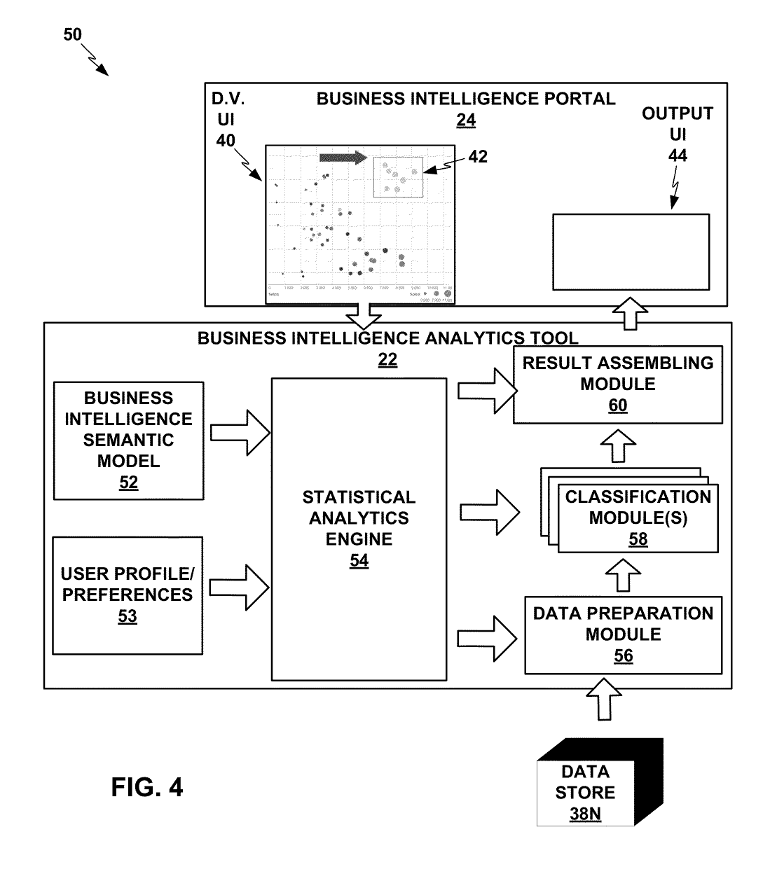

For example, BI analytics tool 22 may generate data visualization UI 40 as a structured representation of a set of data, e.g., in the form of a scatter plot 40 that represents the set of data in a data visualization user interface, in this example. A user may make a user selection of a subset 42 of data items for a cluster of outliers in the scatter plot 40 of data. BI analytics tool 22 may invoke a decision tree classification algorithm to determine or select one or more possible business intelligence factors that might explain these outliers in the selected subset of data. BI analytics tool 22 may generate an output representing a statistical analysis of the selected subset of data based at least in part on the one or more business intelligence factors. The output representing the statistical analysis of the selected subset of data based at least in part on the one or more business intelligence factors may be useful to the user in investigating characteristics of the selected subset of data, or explanations for why the selected subset of data are different than the rest of the data or than other portions of the data. BI analytics tool 22 may apply an analytical process to the selected subset of data 42 together with information from a BI semantic model, as further discussed below with reference to FIG. 4.

FIG. 4 is a conceptual block diagram of an example business intelligence (BI) software system 50 for applying statistical analysis techniques to selected subsets of data in combination with information from a BI semantic model, in accordance with an example of this disclosure. BI software system 50 includes BI analytics tool 22, BI portal 24, and one or more data stores 38. BI software system 50 may be an example implementation of specific aspects of computing environment 10 including enterprise business intelligence (BI) system 14 as shown in FIG. 2. BI portal 24 includes data visualization UI 40, including selected subset of data 42, and an analytics result output 44. BI analytics tool 22 includes BI semantic model 52, stored user profile and/or preferences 53, statistical analytics engine 54, data preparation module 56, one or more classification modules 58, and assembling module 60. Each of these portions of BI analytics tool 22 (52-60) may include algorithms, data, and/or other resources for performing certain functions.

Statistical analytics engine 54 of BI analytics tool 22 may identify one or more appropriate statistical analytics techniques to use on the selected subset of data 42. Statistical analytics engine 54 may use BI semantic model 52 as part of identifying the appropriate statistical analytics techniques to use on the selected subset of data 42. Using BI semantic model 52 may include statistical analytics engine 54 selecting one or more business intelligence factors from BI semantic model 52 based at least in part on the selected subset of data 42. Using BI semantic model 52 may also include statistical analytics engine 54 selecting one or more factors from data on user role and/or preferences 53. BI analytics tool 22 may use data preparation module 56 to prepare input data for analysis (e.g., the selected subset of data, one or more remaining portions from the data set), potentially for each of one or more statistical analytics techniques used. BI analytics tool 22 may use one or more classification modules 58 to apply one or more classification algorithms (e.g., a decision tree) to the input data (e.g., the selected subset of data, one or more remaining portions from the data set). Using one or more classification modules 58 may include BI analytics tool 22 performing a statistical analysis of the selected subset of data based at least in part on the selected one or more business intelligence factors selected by BI analytics tool 22 from BI semantic model 52.

BI analytics tool 22 may use assembling module 60 to filter, refine, and/or assemble the results of performing each of the one or more statistical analytics techniques used, and potentially to combine the results of more than one analytical techniques used. BI analytics tool 22 may use result assembling module 60 as part of generating an analytics result output 44 representing a statistical analysis of the selected subset of data 42 based at least in part on the selected one or more business intelligence factors from BI semantic model 52. Various aspects of the functioning of BI analytics tool 22 using BI semantic model 52, data preparation module 56, one or more classification modules 58, and result assembling module 60 are further described as follows.

BI analytics tool 22 may remove arbitrary identifiers or pseudo-identifiers, which don't contribute to valuable business information in an analysis output, from a set of data (e.g., a selected subset of data, another portion of data, a complete set of data). BI analytics tool 22 may also remove redundancies from nested identifiers from a set of data, thereby removing redundant information from an analysis output. In some examples in which BI analytics tool 22 identifies data as being from a specific business domain, BI analytics tool 22 may use data mining techniques based on association or sequence, marketing data, or segmentation analysis, based on the context of a specific business domain. When applied in a BI context, data attributes may have rich metadata associated with them that may be structured into areas such as business concepts, business hierarchies, and business domain, that may be collectively referred to as a business intelligence (BI) model, or more specifically as a BI semantic model 52 in some examples. BI analytics tool 22 may apply a BI semantic model 52 and its metadata in a data analysis process, which may improve the resulting output, in terms of returning relevant and useful information to the user.

BI analytics tool 22 may also select one or more particular statistical analysis techniques to apply to the selected subset of data based on identifiers BI analytics tool 22 detects in the selected subset of data. For example, when BI analytics tool 22 detects temporal identifiers as part of the selected subset of data, BI analytics tool 22 may also apply metric correlation analysis, including lead time detection and lag time detection, on the selected subset of data based at least in part on the temporal identifiers. These and other examples are further explained below.

Since BI analytics tool 22 may not know in advance at what granularity patterns or rules might be detectable in a selected subset of data, it may apply a classification algorithm (e.g., a decision tree algorithm) to data at different granularities. The decision tree algorithm itself has no knowledge of existing relationships between attributes of the same conceptual data dimension (e.g., overlapping nested geographical identifiers such as Country and City, or overlapping nested temporal identifiers such as Quarter and Month). In other words, the decision tree algorithm does not know that March will always be in Q1 and Ottawa always lies in Canada. As a result, the decision tree algorithm acting by itself would always return the useless generic higher level descriptor (“Q1”) along with the lower level specific ones (“March”). To resolve this issue, BI analytics tool 22 may use business-relevant information from BI semantic model 52 to prepare the data for analysis, to select appropriate statistical analysis techniques, and to assemble and filter the results of the analysis.

BI semantic model 52 may include a business ontology with concepts that represent aspects of specific business knowledge, as well as aspects of common knowledge that correspond to a description of systems and relations that are relevant to the business domain. As one example, through this business ontology, BI semantic model 52 may include a conceptual model indicating how a business organizes its product offerings in categories (e.g., product lines, brands, and individual items). As another example, BI semantic model 52 may include a conceptual model indicating that a sales order may typically include one or more sales items, a base price for each of the one or more sales items, potentially a discount on the base price, and a client that placed the sales order, among other things. As another example, BI semantic model 52 may include an employee concept with information on how an employee may be described with a first name, a last name, an employee company ID, a social security number, a job title, a compensation and benefits package, a position within a business organization chart with relationships with other employees within a business, and potentially additional information.

As another example, BI semantic model 52 may include conceptual information on how dates may be included in nested temporal identifiers that may describe months, quarters, and years, with certain months always belonging within certain quarters (e.g., January, February, and March always belonging within Q1 (first quarter)). As another example, BI semantic model 52 may include conceptual information on nested geographical identifiers and how certain cities may be included within certain provinces or states, which may in turn be included in certain countries, which themselves may be grouped in certain continents or other multi-country areas (e.g., Ottawa, Toronto, and Hamilton are cities that are within the province of Ontario, which is within the country of Canada, which is part of North America). BI semantic model 52 may include conceptual information on how business units may be assigned to certain groupings of nested geographical identifiers (e.g., the provinces of Ontario and Quebec may be assigned to a single sales district of a business, and the sales district may be defined as a portion of a larger sales region that also includes other sales districts that may be defined to include certain provinces and/or states and/or individual cities).

BI analytics tool 22 may use data preparation module 56 to discard non-relevant attributes over an input data set (e.g., selected subset of data 42) based on BI semantic model 52. BI analytics tool 22 may also use data preparation module 56 to select one or more analysis techniques to apply to the input data set. For example, BI analytics tool 22 may use data preparation module 56 to identify one or more semantic categories to which the input data set belongs, and select one or more analysis techniques that are suitable for the one or more semantic categories. If the input data set belongs to multiple semantic categories, BI analytics tool 22 may use data preparation module 56 to assign different portions of the input data set in different semantic categories to different analytical techniques suitable for the respective semantic categories.

BI analytics tool 22 may use a metadata model included in BI semantic model 52 to identify and discard attributes in an input data set (e.g., selected subset of data 42) that are arbitrary identifiers, such as record keys. (An “input data set” may refer to any input data set, such as selected subset of data 42, in some examples.) BI analytics tool 22 may look up the appropriate attribute in a metadata model included in BI semantic model 52 to determine whether the attributes are arbitrary identifiers.

Decision tree algorithms may ordinarily take record keys as significant data, and act on record keys being different among each of a number of data records. A decision tree algorithm ordinarily may generate an analysis with final rules that are of little or no value or statistical significance, because they are based on arbitrary identifiers. Instead of this, BI analytics tool 22 may use BI semantic model 52 to determine data attributes that are merely arbitrary identifiers and exclude them from analysis, prior to performing the analysis (e.g., applying one or more classification modules 58). This may not only exclude irrelevant data from the final analysis, but also reduce the computational burden and processing time of performing the analysis, by reducing the amount of data the classification modules 58 must be applied to. Identifying and eliminating arbitrary identifiers in the input data may therefore increase both the relevance and the speed with which BI analytics tool 22 may generate analytics result output 44.

In addition to identifying and eliminating arbitrary identifiers from the input data (e.g., selected subset of data 42) based on the information from BI semantic model 52, data preparation module 56 may also function to identify overlapping identifiers, and eliminate redundant identifiers from the overlapping identifiers. Overlapping identifiers may contain real data as opposed to arbitrary identifiers (such as row ID's), but may define different aspects or different hierarchical levels of the same concept, or alternative attributes to describe the same concept. For example, the input data may include an employee identifier, an employee full name, and an employee social security number, all to describe the same employee, for each of a number of employees. The input data may also include overlapping identifiers in the form of nested hierarchical identifiers in any of a number of dimensions such as a temporal dimension, a geographical dimension, or an administrative dimension.

In the case of non-hierarchical overlapping identifiers among the input data set, such as employee name, employee ID number, and employee social security number, BI analytics tool 22 executing data preparation module 56 may select a single one of the overlapping identifiers to include in the data analysis, while excluding the other overlapping identifiers from the data analysis (while optionally associating the other identifiers with the included identifier in the analytics result output 44). BI analytics tool 22 may select which of the overlapping identifiers to consider based on information from BI semantic model 52 if possible. For example, the input data set may include an employee company ID, an employee full name, and an employee social security number for each of a number of employees, forming redundant overlapping identifiers for each employee. BI analytics tool 22 may select the employee company ID to use for processing the statistical analysis, rather than applying analysis techniques across each of the redundant overlapping identifiers.

In the case of overlapping hierarchical identifiers among the input data set, such as overlapping temporal hierarchical identifiers (e.g., quarter and month) or overlapping geographical hierarchical identifiers (e.g., city and nation), BI analytics tool 22 executing data preparation module 56 may select a single one of the overlapping hierarchical identifiers to include in the data analysis, while excluding the other overlapping hierarchical identifiers from the data analysis (while optionally associating the other identifiers with the included hierarchical identifier in the analytics result output 44). Additionally, BI analytics tool 22 executing data preparation module 56 may select the most specific one of the overlapping hierarchical identifiers to include in the data analysis, while excluding the other, more general overlapping hierarchical identifiers from the data analysis.

For example, an input data set may include overlapping nested geographic identifiers for cities, provinces or states, and nations, and BI analytics tool 22 may select the geographic identifiers for cities for inclusion in the analysis, since the city identifier is the most specific one of the overlapping nested geographic identifiers. BI analytics tool 22 may exclude the geographic identifiers for provinces or states and nations from the data analysis. As additional examples, an input data set may include overlapping nested temporal identifiers for months and quarters, and overlapping nested administrative identifiers for sales districts and sales regions, and BI analytics tool 22 may select the month identifiers and the sales district identifiers for analysis, as the most specific options among their respective overlapping sets, while excluding the quarter identifiers and the sales regions identifiers from the analysis. Each of these hierarchies may be modeled and indicated as business-relevant concepts in BI semantic model 52.

BI analytics tool 22 may use business concepts or metadata model information from BI semantic model 52 to evaluate arbitrary identifiers and redundant overlapping identifiers, and to identify the most specific available identifier from among redundant overlapping identifiers, in order to remove extraneous data prior to running an analysis, and to perform the analysis with only salient information. As with the arbitrary identifiers, identifying and eliminating redundant overlapping identifiers in the input data prior to performing the analysis may therefore increase both the relevance and the speed with which BI analytics tool 22 may generate analytics result output 44.

In some cases, BI semantic model 52 may indicate that attributes with two or more hierarchical levels may include at least some non-redundant information. In those cases, BI analytics tool 22 may preserve the attributes with the two or more hierarchical levels in the input data through the processing of a statistical analysis (e.g., with one or more classification modules 58). BI analytics tool 22 may subject the attributes with the two or more hierarchical levels to filtering after the analysis (e.g., with assembling module 60), which may reduce or eliminate information that may have become irrelevant or redundant once the analysis is complete, or that may have become apparent as irrelevant or redundant once the analysis is complete.

As noted above, statistical analytics engine 54 of BI analytics tool 22 may use BI semantic model 52 to identify one or more statistical analytics techniques that are particularly appropriate to use on the selected subset of data 42. Some examples of this are as follows. In one example, BI semantic model 52 may include business concepts that categorize individual products into groups and relationships, and statistical analytics engine 54 may apply analyses that test for associations among sales of a particular product with sales of products in the same group or in related groups. As another example, statistical analytics engine 54 may identify a particular semantic area from BI semantic model 52 that may be relevant to the selected subset of data 42. In one example, selected subset of data 42 may include a number of properties or metrics measured over time, which may include not only business data such as particular products sold in particular areas over time, but also weather data such as temperature, sunshine, rain, and snow, over the same period of time in the same particular areas. BI semantic model 52 may indicate the weather data as one potentially relevant area to the sales data.

Statistical analytics engine 54 may apply statistical analysis techniques comparing the weather data with the sales data in the same times and locations as the sales data. Since the selected subset of data 42 involves a sequence of metrics over time, BI analytics tool 22 may select a metric correlation analysis to apply to the sales data and the weather data. The metric correlation analysis may include lead detection and lag detection between metrics, e.g., detecting any potential trends in the sales data that are correlated with the weather data with a lead time and/or a lag time. Examples of this might include detecting extraordinarily high sales of snow shovels a short time after a substantial snowfall (or with a lag time after the snow fall), or extra sales of sunscreen a short time before a period of high temperatures and high occurrences of sunshine (or with a lead time ahead of the hot and sunny weather).

If the selected data involve discrete attributes, BI analytics tool 22 may select a classification analysis technique. Depending on the selected data involving a particular domain or industry associated with identified domain-specific concepts in the BI model 52, BI analytics tool 22 may select a particular analysis technique prior to other analysis techniques in a priority ranking associated with the domain-specific concepts, such as analyzing sales contributions prior to sales distributions, for example. Depending on the selected data, BI analytics tool 22 may perform contribution analysis only on appropriate metrics, such as on total sales but not on average prices, for example. BI analytics tool 22 may also select multiple statistical analysis techniques and rank the selected analytical techniques in an order to be used.

BI analytics tool 22 may also evaluate one or more factors from data on user role and/or preferences 53, and how the user role/preferences 53 relates to the domain-specific concepts from BI model 52, as part of a process of selecting and ranking the analysis techniques. For example, the user role/preferences 53 may indicate a user role in marketing, sales, or product management. As one example, BI analytics tool 22 may combine an evaluation of business concepts from BI model 52 with a user role in marketing from user role/preferences 53 to focus on aspects of the business concepts relevant to marketing in how BI analytics tool 22 selects and ranks the analysis techniques to be used.

Thus, BI analytics tool 22 may select business intelligence factors from BI semantic model 52 based on selected subset of data 42, which may include BI analytics tool 22 selecting one or more statistical analysis techniques to apply in one or more classification modules 58 based on information by BI semantic model 52 indicating what is relevant to selected subset of data 42. BI analytics tool 22 may perform a statistical analysis of selected subset of data 42 based at least in part on the selected one or more business intelligence factors indicated by BI semantic model 52. This may include BI analytics tool 22 applying the selected one or more statistical analysis techniques in one or more classification modules 58 to selected subset of data 42. BI analytics tool 22 may rank the one or more statistical analysis techniques indicated by BI semantic model 52 as relevant to selected subset of data 42 in a ranked order based at least in part on BI semantic model 52. BI analytics tool 22 may apply the selected one or more statistical analysis techniques to selected subset of data 42. This may include BI analytics tool 22 applying the selected one or more statistical analysis techniques in the ranked order.

BI analytics tool 22 may perform the statistical analysis of selected subset of data 42 based at least in part on the selected one or more business intelligence factors from BI semantic model 52. This may include BI analytics tool 22 selecting an order of statistical analysis techniques to apply to selected subset of data 42 based at least in part on business concepts comprised in the business intelligence factors from BI semantic model 52. In one example, selected subset of data 42 may include data on sales. BI analytics tool 22 may then select an order of statistical analysis techniques to apply to selected subset of data 42 based at least in part on business concepts comprised in the business intelligence factors from BI semantic model 52. For example, BI analytics tool 22 may have algorithms or modules for analysis techniques that include a sales contribution analysis technique and a sales distribution analysis technique, and BI analytics tool 22 may select the sales contribution analysis technique to apply to selected subset of data 42 first, and select the sales distribution analysis technique to apply to selected subset of data 42 subsequent to applying the sales contribution analysis technique.

One or more classification modules 58 may include a decision tree algorithm, for example. BI analytics tool 22 may apply a decision tree algorithm from classification modules 58 to the selected subset of data 42 over the underlying data set, or in comparison to all or a portion of the underlying data set. BI analytics tool 22 may thereby generate an analytics result output 44 that represents the statistical analysis of the selected subset of data based at least in part on one or more business intelligence factors taken from BI semantic model 52. For example, the output may translate or convert decision trees from a decision tree algorithm analysis of the selected subset of data into a set of rules. The rules may characterize what sets the selected subset of data 42 apart relative to the remaining data.

The rules presented by BI analytics tool 22 in the analytics result output 44 may be further focused on particular characteristics of the selected subset of data 42 that are business-relevant, based on the BI model. BI analytics tool 22 may consult the BI model 52 and determine that some initial results are arbitrary identifiers that aren't relevant for a business analysis, or that some initial results are redundant forms of nested identifiers that don't add any additional relevant information beyond a first level of the nested identifiers (e.g., identifiers for quarters don't add additional information beyond identifiers for months). BI analytics tool 22 may insert processing based on the BI model 52 into the execution of the analysis techniques to the selected subset of data 42, to improve the business relevance of the resulting output 44.

As noted above, BI analytics tool 22 may use filtering module 60 to filter, refine, and/or assemble the results of performing each of the one or more statistical analytics techniques used, and potentially to combine the results of more than one analytical techniques. BI analytics tool 22 using BI semantic model 52 and filtering module 60 may filter and assemble results of performing the statistical analysis of the selected subset of data based on the selected BI factors. The analytics result output 44 representing the statistical analysis of the selected subset of data comprises the filtered and assembled results.

Assembling module 60 may also make use of BI semantic model 52, for example, to filter out information that results from the analysis techniques applied by one or more classification modules 58 but that are indicated by business concepts or metadata from BI semantic model 52 to be obvious or not relevant to a business end user. Assembling module 60 may also format the analytics result output 44 resulting from the analysis by one or more classification modules 58 into a suitable format that facilitates viewing and understanding by a business end user. For example, assembling module 60 may replace obscure attribute value names with more descriptive names from concept labels in the analytics result output 44. In one example, the input data may include an attribute called “product_group_id” and each of the data items in the input data may include a coded entry for this attribute. Assembling module 60 may look up the attribute in BI semantic model 52 and replace the attribute with a plain English descriptive name, so that instead of generating analytics result output 44 to include obscure product codes such as “product_group_id=[PG12343, PG87234],” analytics result output 44 instead includes descriptive names such as “product_group_id=[lawnmowers, leafblowers].”

Assembling module 60 may also aggregate split concepts back into a more generic concept, based on a dimensional model indicated by BI semantic model 52. For example, if the analysis results include a year and all four quarters, e.g., Year=2011 AND Quarter=[Q1,Q2,Q3,Q4], assembling module 60 may discard the quarter identifier attribute. Assembling module 60 may also rank results according to their importance in a particular domain or industry, as may be indicated by business concepts listed in BI semantic model 52. Assembling module 60 may also filter the analysis results according to relationships among data attributes indicated by business concepts listed in BI semantic model 52, such as a correlation between sales and prices.

In one example, in the course of BI analytics tool 22 executing a decision tree classification algorithm on the selected subset of data 42, BI analytics tool 22 may generate the following conclusions or rules: most items in the selected subset of data 42 have a property TransactionID contained in the set [2345612, 123532, 124321, 456342, 345324, 239857, 345232]; most items in the selected subset of data 42 have nested geographic properties Country=Canada AND City=Ottawa; and most items in the selected subset of data 42 have nested temporal properties Quarter=Q1 and Month=March and Year=2011. In this example, BI analytics tool 22 may determine that the property TransactionID is an arbitrary identifier, e.g., an identifier that does not convey useful information for business analysis, or that do not help explain what might characterize the selected subset of data or distinguish the selected subset of data 42 from the other portions of the data set. BI analytics tool 22 may remove the arbitrary identifier of the property TransactionID from the selected subset of data 42 as part of preparing and generating an output that represents the statistical analysis of the selected subset of data based on the selected BI factors. By so doing, BI analytics tool 22 may remove information of limited usefulness from the output representing the statistical analysis of the selected subset of data based on the selected BI factors, thereby making the output simpler and more relevant to a user such as a business manager or business analyst.

In this example, BI analytics tool 22 may also identify that the properties Country=Canada AND City=Ottawa are nested geographical identifiers, e.g., that the city Ottawa is contained within the country of Canada; and that the properties Quarter=Q1 and Month=March and Year=2011 are nested temporal identifiers, e.g., that the month of March is contained within the quarter Q1 and the quarter Q1 may be contained within the year 2011. Additionally, BI analytics tool 22 may identify that in some cases, the nested identifiers are redundant: since the city Ottawa is always contained within the country Canada, the country identifier may be considered a redundancy of the nested geographical identifiers, and since the month of March is always contained within the quarter Q1, the quarter identifier may be considered a redundancy of the nested temporal identifier. On the other hand, the month of March (and the quarter Q1) may be contained within any of many different options for the year identifier, so BI analytics tool 22 may identify the year identifier 2011 as a nested but non-redundant temporal identifier, in this example.

Performing the statistical analysis of selected subset of data 42 based at least in part on the selected BI factors from BI semantic model 52 may include applying a classification algorithm trained on a set of already classified data to classify data in selected subset of data 42 into at least one of two or more classification sets. The classification algorithms may include a decision tree algorithm, and performing the statistical analysis of selected subset of data 42 based at least in part on BI factors from BI semantic model 52 may include selecting top level nodes of the decision tree as indicating differentiating factors of selected subset of data 42 compared to a remaining portion of the set of data 40. Performing the statistical analysis of selected subsets of data 42 based on the BI factors from BI semantic model 52 may further include generating one or more rules that summarize the differentiating factors of selected subsets of data 42 compared to the remaining portion of the set of data 40, as indicated by the top level nodes of the decision tree. BI analytics tools 22 may use the rules that summarize the differentiating factors of selected subsets of data 42 in rearranging or consolidating the information to be presented in the output.

BI analytics tool 22 may thus generate an output representing the statistical analysis of the selected subset of data such that BI analytics tool 22 removes redundancies of overlapping identifiers from the selected subset of data, where the overlapping identifiers may be nested temporal identifiers (e.g., the redundant information of March being part of Q1) or nested geographical identifiers (e.g., the redundant information of Ottawa being part of Canada), for example. In this example, BI analytics tool 22 may generate an output representing the statistical analysis of the selected subset of data that presents data merely for Ottawa in March 2011, without presenting redundant information involved in Ottawa being part of Canada or March being part of Q1.

In another example, BI analytics tool 22 may identify overlapping identifiers that include two or more nested administrative identifiers, such as a regional sales area that contains smaller sales districts as defined by a company, or such as an engineering department that contains a number of smaller individual product engineering groups within a company, for example. In some examples of this disclosure, BI analytics tool 22 may determine from a business intelligence model that explicitly reiterating information about nested administrative identifiers such as these may be redundant and not useful in an output representing a statistical analysis of selected subsets of data. BI analytics tool 22 may then remove the redundancies in the nested administrative identifiers in the output.

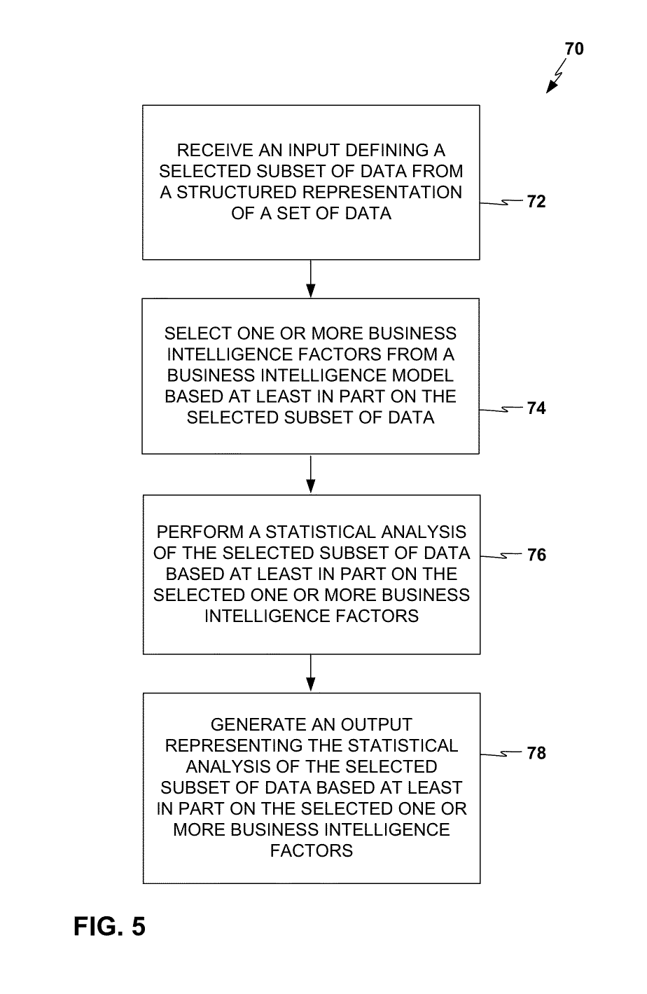

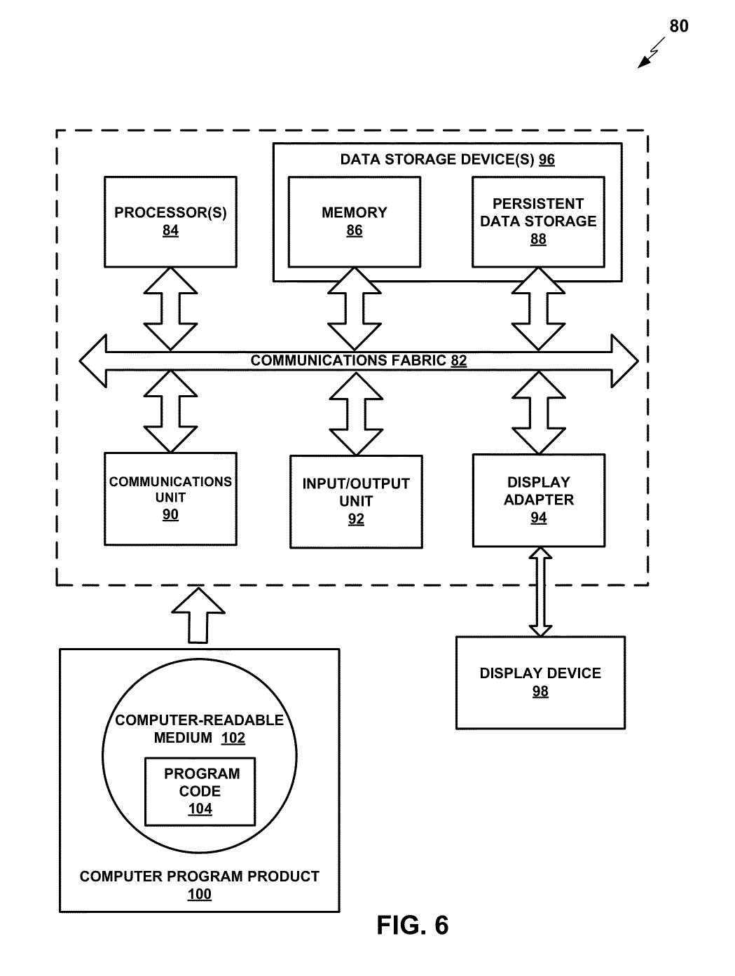

FIG. 5 shows a flowchart for an example process 70 for BI analytics tool 22 to apply statistical analysis techniques to selected subsets of data in combination with information from a BI semantic model, in accordance with an example of this disclosure. BI analytics tool 22 may apply process 70 executing on one or more computing devices in computing environment 10 and/or enterprise BI system 14. The one or more computing devices that implement BI analytics tool 22 or that apply process 70 may include one or more servers, computers, processors, etc., such as computer device 80 and/or one or more processors 84 described below with reference to FIG. 6. A “computing device” as described herein may refer to any one or more processors or one or more computer devices, including any of the servers, computers, processors, etc. described herein, including any one or more processors included as part of one or more computer devices. A “computing device” as described herein may also include one or more data storage devices on which computer program code for implementing process 70 may be stored, in a long-term or non-volatile storage device and/or in a temporary or volatile storage device, as further described below.

One or more aspects or functions of process 70 may also be embodied in a computer program product that may be read, implemented, and/or executed by any of the computing devices described herein. A “computing device” as described herein may refer, for example, to a laptop or desktop computer, a tablet computer or smartphone, one or more real or virtual servers within or external to enterprise BI system 14, one or more data centers, a cloud computing service, or any other implementation of a computing resource, or any one or more processors included in any type of computer device. The one or more processors may include one or more central processing units (CPU's), one or more processing cores of a CPU, one or more graphics processing units (GPU's), one or more processing cores of a GPU, one or more field-programmable gate arrays (FGPA's), one or more programmable logic arrays (PLA's), one or more special-purpose co-processors, or any other type of device capable of processing or executing executable instructions.

BI analytics tool 22, implemented by a computing device, may receive an input defining a selected subset of data from a structured representation of a set of data (e.g., selected subset of data 42 in a data visualization U.I. 40) (72). BI analytics tool 22, implemented by a computing device, may select one or more BI factors from a BI semantic model based at least in part on the selected subset of data (e.g., BI factors from a BI semantic model 52 based at least in part on the selected subset of data 42) (74). BI analytics tool 22, implemented by a computing device, may perform a statistical analysis of the selected subset of data based at least in part on the selected one or more business intelligence factors (e.g., a statistical analysis of selected subset of data 42 based at least in part on the selected one or more BI factors from BI semantic model 52) (76). BI analytics tool 22, implemented by a computing device, may generate an output representing the statistical analysis of the selected subset of data based at least in part on the selected one or more business intelligence factors (e.g., generate analytics result output 44 representing the statistical analysis of selected subset of data 42 based at least in part on the selected one or more BI factors from BI semantic model 52) (78). BI analytics tool 22 may perform additional functions using BI semantic model 52. For example, BI analytics tool 22 may use BI semantic model 52 to filter and assemble results of performing the statistical analysis of the selected subset of data based at least in part on the selected one or more business intelligence factors. The output representing the statistical analysis of the selected subset of data may then include the filtered and assembled results.

In some examples of process 70 of FIG. 5, the structured representation of the set of data includes a graph that represents the set of data, and receiving the input defining the selected subset of data from the structured representation of the set of data include receiving a user input via a user interface selecting a portion of the graph. In some examples of process 70 of FIG. 5, performing the statistical analysis of the selected subset of data includes performing the statistical analysis of the selected subset of data in comparison with a remaining portion of the set of data not included in the selected subset of data. In some examples, the process 70 of FIG. 5 further includes, prior to performing the statistical analysis of the selected subset of data, using the business intelligence model to prepare the selected subset of data for the statistical analysis.

In some examples of process 70 of FIG. 5, performing the statistical analysis of the selected subset of data based at least in part on the selected one or more business intelligence factors includes identifying one or more overlapping identifiers in the selected subset of data, and generating the output representing the statistical analysis of the selected subset of data based at least in part on the selected one or more business intelligence factors includes removing redundancies of the one or more overlapping identifiers from the selected subset of data. In some examples of process 70 of FIG. 5, the one or more overlapping identifiers include two or more nested temporal identifiers. In some examples of process 70 of FIG. 5, performing the statistical analysis of the selected subset of data based at least in part on the selected one or more business intelligence factors further includes applying metric correlation analysis, including lead time detection and lag time detection, on the selected subset of data based at least in part on the two or more nested temporal identifiers. In some examples of process 70 of FIG. 5, the one or more overlapping identifiers include two or more nested geographical identifiers. In some examples of process 70 of FIG. 5, the one or more overlapping identifiers include two or more overlapping administrative identifiers.

In some examples of process 70 of FIG. 5, performing the statistical analysis of the selected subset of data based at least in part on the selected one or more business intelligence factors includes identifying one or more arbitrary identifiers in the selected subset of data, and generating the output representing the statistical analysis of the selected subset of data based at least in part on the selected one or more business intelligence factors includes removing the one or more arbitrary identifiers from the selected subset of data. In some examples of process 70 of FIG. 5, performing the statistical analysis of the selected subset of data based at least in part on the selected one or more business intelligence factors further include applying a classification algorithm trained on a set of previously classified data to classify data in the selected subset of data into at least one of two or more classification sets. In some examples of process 70 of FIG. 5, the classification algorithm includes a decision tree, and performing the statistical analysis of the selected subset of data based at least in part on the selected one or more business intelligence factors further includes selecting top-level nodes of the decision tree as indicating differentiating factors of the selected subset of data compared to a remaining portion of the set of data not included in the selected subset of data. In some examples of process 70 of FIG. 5, performing the statistical analysis of the selected subset of data based at least in part on the selected one or more business intelligence factors further includes generating one or more rules that summarize the differentiating factors of the selected subset of data compared to the remaining portion of the set of data, as indicated by the top level nodes of the decision tree.

In some examples of process 70 of FIG. 5, selecting the one or more business intelligence factors from the business intelligence model based at least in part on the selected subset of data includes selecting one or more statistical analysis techniques indicated by the business intelligence model as relevant to the selected subset of data, and performing the statistical analysis of the selected subset of data based at least in part on the selected one or more business intelligence factors includes applying the selected one or more statistical analysis techniques to the selected subset of data. Some examples of process 70 of FIG. 5 further include ranking the one or more statistical analysis techniques indicated by the business intelligence model as relevant to the selected subset of data in a ranked order based at least in part on the business intelligence model, wherein applying the selected one or more statistical analysis techniques to the selected subset of data includes applying the selected one or more statistical analysis techniques in the ranked order.

In some examples of process 70 of FIG. 5, performing the statistical analysis of the selected subset of data based at least in part on the selected one or more business intelligence factors includes selecting an order of statistical analysis techniques to apply to the selected subset of data based at least in part on business concepts included in the business intelligence factors. In some examples of process 70 of FIG. 5, the selected subset of data includes data on sales, and wherein selecting the order of statistical analysis techniques to apply to the selected subset of data based at least in part on business concepts included in the business intelligence factors includes selecting a sales contribution analysis technique to apply to the selected subset of data, and selecting a sales distribution analysis technique to apply to the selected subset of data subsequent to applying the sales contribution analysis technique. Some examples of process 70 of FIG. 5 further include using the business intelligence model to filter and assemble results of performing the statistical analysis of the selected subset of data based at least in part on the selected one or more business intelligence factors, wherein the output representing the statistical analysis of the selected subset of data includes the filtered and assembled results.

FIG. 6 is a block diagram of a computer system 80 that may be used to implement a BI analytics tool 22 as part of a BI computing system, according to an illustrative example. Computer system 80 may be a server such as one of web servers 14A or application servers 14B as depicted in FIG. 2. Computer system 80 may also be any server for providing an enterprise business intelligence application in various examples, including a virtual server that may be run from or incorporate any number of computing devices. A computing device may operate as all or part of a real or virtual server, and may be or incorporate a workstation, server, mainframe computer, notebook or laptop computer, desktop computer, tablet, smartphone, feature phone, or other programmable data processing apparatus of any kind Other implementations of a computer system 80 may include a computer having capabilities or formats other than or beyond those described herein.

In the illustrative example of FIG. 6, computer system 80 includes communications fabric 82, which provides communications between one or more processor(s) 84 (“processors 84”), memory 86, persistent data storage 88, communications unit 90, and input/output (I/O) unit 92. Communications fabric 82 may include a dedicated system bus, a general system bus, multiple buses arranged in hierarchical form, any other type of bus, bus network, switch fabric, or other interconnection technology. Communications fabric 82 supports transfer of data, commands, and other information between various subsystems of computer system 80.

Processors 84 may be a programmable central processing unit (CPU) configured for executing programmed instructions stored in memory 86. In another illustrative example, processors 84 may be implemented using one or more heterogeneous processor systems in which a main processor is present with secondary processors on a single chip. In yet another illustrative example, processors 84 may include a symmetric multi-processor system containing multiple processors of the same type. Processors 84 may include a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, processors 84 may include a multi-core processor, such as a dual core or quad core processor, for example. Processors 84 may include multiple processing chips on one die, and/or multiple dies on one package or substrate, for example. Processors 84 may also include one or more levels of integrated cache memory, for example. In various examples, processors 84 may comprise one or more CPUs distributed across one or more locations.

One or more data storage devices 96 (“storage devices 96”) include memory 86 and persistent data storage 88, which are in communication with processors 84 through communications fabric 82. Memory 86 can include a random access semiconductor memory (RAM) for storing application data, i.e., computer program data, for processing. While memory 86 is depicted conceptually as a single monolithic entity, in various examples, memory 86 may be arranged in a hierarchy of caches and in other memory devices, in a single physical location, or distributed across a plurality of physical systems in various forms. While memory 86 is depicted physically separated from processors 84 and other elements of computer system 80, memory 86 may refer equivalently to any intermediate or cache memory at any location throughout computer system 80, including cache memory proximate to or integrated with one or more processors 84 or with individual cores of one or more processors 84.

Persistent data storage 88 may include one or more hard disc drives, solid state drives, flash drives, rewritable optical disc drives, magnetic tape drives, or any combination of these or other data storage media. Persistent data storage 88 may store computer-executable instructions or computer-readable program code for an operating system, application files comprising program code, data structures or data files, and any other type of data. These computer-executable instructions may be loaded from persistent data storage 88 into memory 86 to be read and executed by one or more processors 84 or other processors. Storage devices 96 may also include any other hardware elements capable of storing information, such as, for example and without limitation, data, program code in functional form, and/or other suitable information, either on a temporary basis and/or a permanent basis.

Persistent data storage 88 and memory 86 are examples of physical, tangible, non-transitory computer-readable data storage devices. Storage devices 96 may include any of various forms of volatile memory that may require being periodically electrically refreshed to maintain data in memory, while those skilled in the art will recognize that this also constitutes an example of a physical, tangible, non-transitory computer-readable data storage device. Executable instructions may be stored on a non-transitory medium when program code is loaded, stored, relayed, buffered, or cached on a non-transitory physical medium or device, including if only for only a short duration or only in a volatile memory format.

One or more processors 84 can also be suitably programmed to read, load, and execute computer-executable instructions or computer-readable program code for a BI analytics tool 22, as described in greater detail above. This program code may be stored on memory 86, persistent data storage 88, or elsewhere in computer system 80. This program code may also take the form of program code 104 stored on computer-readable medium 102 comprised in computer program product 100, and may be transferred or communicated, through any of a variety of local or remote means, from computer program product 100 to computer system 80 to be enabled to be executed by one or more processors 84, as further explained below.

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, or any other suitable operating system. Processors 84 can be suitably programmed to read, load, and execute instructions of the operating system.

Communications unit 90, in this example, provides for communications with other computing or communications systems or devices. Communications unit 90 may provide communications through the use of physical and/or wireless communications links. Communications unit 90 may include a network interface card for interfacing with a LAN 16, an Ethernet adapter, a Token Ring adapter, a modem for connecting to a transmission system such as a telephone line, or any other type of communication interface. Communications unit 90 can be used for operationally connecting many types of peripheral computing devices to computer system 80, such as printers, bus adapters, and other computers. Communications unit 90 may be implemented as an expansion card or be built into a motherboard, for example.

The input/output unit 92 can support devices suited for input and output of data with other devices that may be connected to computer system 80, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 92 may also include any type of interface for video output in any type of video output protocol and any type of monitor or other video display technology, in various examples. It will be understood that some of these examples may overlap with each other, or with example components of communications unit 90 or storage devices 96. Input/output unit 92 may also include appropriate device drivers for any type of external device, or such device drivers may reside elsewhere on computer system 80 as appropriate.

Computer system 80 also includes a display adapter 94 in this illustrative example, which provides one or more connections for one or more display devices, such as display device 98, which may include any of a variety of types of display devices. It will be understood that some of these examples may overlap with example components of communications unit 90 or input/output unit 92. Input/output unit 92 may also include appropriate device drivers for any type of external device, or such device drivers may reside elsewhere on computer system 80 as appropriate. Display adapter 94 may include one or more video cards, one or more graphics processing units (GPUs), one or more video-capable connection ports, or any other type of data connector capable of communicating video data, in various examples. Display device 98 may be any kind of video display device, such as a monitor, a television, or a projector, in various examples.

Input/output unit 92 may include a drive, socket, or outlet for receiving computer program product 100, which comprises a computer-readable medium 102 having computer program code 104 stored thereon. For example, computer program product 100 may be a CD-ROM, a DVD-ROM, a Blu-Ray disc, a magnetic disc, a USB stick, a flash drive, or an external hard disc drive, as illustrative examples, or any other suitable data storage technology.

Computer-readable medium 102 may include any type of optical, magnetic, or other physical medium that physically encodes program code 104 as a binary series of different physical states in each unit of memory that, when read by computer system 80, induces a physical signal that is read by one or more processors 84. The physical signal corresponds to the physical states of the basic data storage elements of storage medium 102, and that induces corresponding changes in the physical state of one or more processors 84. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of one or more processors 84, thereby physically causing or configuring one or more processors 84 to generate physical outputs that correspond to the computer-executable instructions, in a way that causes computer system 80 to physically assume new capabilities that it did not have until its physical state was changed by loading the executable instructions comprised in program code 104.

In some illustrative examples, program code 104 may be downloaded over a network to storage devices 96 from another device or computer system for use within computer system 80. Program code 104 comprising computer-executable instructions may be communicated or transferred to computer system 80 from computer-readable medium 102 through a hard-line or wireless communications link to communications unit 90 and/or through a connection to input/output unit 92. Computer-readable medium 102 comprising program code 104 may be located at a separate or remote location from computer system 80, and may be located anywhere, including at any remote geographical location anywhere in the world, and may relay program code 104 to computer system 80 over any type of one or more communication links, such as the Internet and/or other packet data networks. The program code 104 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 104 may be transmitted from a source computer-readable medium 102 over non-tangible media, such as communications links or wireless transmissions containing the program code 104. Program code 104 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computer system 80.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for applying business intelligence concepts in a statistical analysis of data, the method comprising:
receiving, by one or more computing devices, an input defining a selected subset of data from a structured representation of a set of data;
selecting, by one or more computing devices, one or more business intelligence factors from a business intelligence model based at least in part on the selected subset of data;
performing, by one or more computing devices, a statistical analysis of the selected subset of data based at least in part on the selected one or more business intelligence factors; and
generating, by one or more computing devices, an output representing the statistical analysis of the selected subset of data based at least in part on the selected one or more business intelligence factors.

2. The method of claim 1,
wherein the structured representation of the set of data comprises a graph that represents the set of data, and
wherein receiving the input defining the selected subset of data from the structured representation of the set of data comprises receiving a user input via a user interface selecting a portion of the graph.

3. The method of claim 1, wherein performing the statistical analysis of the selected subset of data comprises performing the statistical analysis of the selected subset of data in comparison with a remaining portion of the set of data not included in the selected subset of data.

4. The method of claim 1, further comprising, prior to performing the statistical analysis of the selected subset of data, using the business intelligence model to prepare the selected subset of data for the statistical analysis.

5. The method of claim 1,
wherein performing the statistical analysis of the selected subset of data based at least in part on the selected one or more business intelligence factors comprises identifying one or more overlapping identifiers in the selected subset of data, and
wherein generating the output representing the statistical analysis of the selected subset of data based at least in part on the selected one or more business intelligence factors comprises removing redundancies of the one or more overlapping identifiers from the selected subset of data.

6. The method of claim 5, wherein the one or more overlapping identifiers comprise two or more nested temporal identifiers.

7. The method of claim 6, wherein performing the statistical analysis of the selected subset of data based at least in part on the selected one or more business intelligence factors further comprises applying metric correlation analysis, including lead time detection and lag time detection, on the selected subset of data based at least in part on the two or more nested temporal identifiers.

8. The method of claim 5, wherein the one or more overlapping identifiers comprise two or more nested geographical identifiers.

9. The method of claim 5, wherein the one or more overlapping identifiers comprise two or more overlapping administrative identifiers.

10. The method of claim 1,
wherein performing the statistical analysis of the selected subset of data based at least in part on the selected one or more business intelligence factors comprises identifying one or more arbitrary identifiers in the selected subset of data, and
wherein generating the output representing the statistical analysis of the selected subset of data based at least in part on the selected one or more business intelligence factors comprises removing the one or more arbitrary identifiers from the selected subset of data.

11. The method of claim 1, wherein performing the statistical analysis of the selected subset of data based at least in part on the selected one or more business intelligence factors comprises:
applying a classification algorithm trained on a set of previously classified data to classify data in the selected subset of data into at least one of two or more classification sets.

12. The method of claim 11,
wherein the classification algorithm comprises a decision tree, and
wherein performing the statistical analysis of the selected subset of data based at least in part on the selected one or more business intelligence factors further comprises selecting top-level nodes of the decision tree as indicating differentiating factors of the selected subset of data compared to a remaining portion of the set of data not included in the selected subset of data.

13. The method of claim 12, wherein performing the statistical analysis of the selected subset of data based at least in part on the selected one or more business intelligence factors further comprises generating one or more rules that summarize the differentiating factors of the selected subset of data compared to the remaining portion of the set of data, as indicated by the top level nodes of the decision tree.

14. The method of claim 1,
wherein selecting the one or more business intelligence factors from the business intelligence model based at least in part on the selected subset of data comprises selecting one or more statistical analysis techniques indicated by the business intelligence model as relevant to the selected subset of data, and
wherein performing the statistical analysis of the selected subset of data based at least in part on the selected one or more business intelligence factors comprises applying the selected one or more statistical analysis techniques to the selected subset of data.

15. The method of claim 14, further comprising:
ranking the one or more statistical analysis techniques indicated by the business intelligence model as relevant to the selected subset of data in a ranked order based at least in part on the business intelligence model,
wherein applying the selected one or more statistical analysis techniques to the selected subset of data comprises applying the selected one or more statistical analysis techniques in the ranked order.

16. The method of claim 1, wherein performing the statistical analysis of the selected subset of data based at least in part on the selected one or more business intelligence factors comprises selecting an order of statistical analysis techniques to apply to the selected subset of data based at least in part on business concepts comprised in the business intelligence factors.

17. The method of claim 16, wherein the selected subset of data comprises data on sales, and wherein selecting the order of statistical analysis techniques to apply to the selected subset of data based at least in part on business concepts comprised in the business intelligence factors comprises selecting a sales contribution analysis technique to apply to the selected subset of data, and selecting a sales distribution analysis technique to apply to the selected subset of data subsequent to applying the sales contribution analysis technique.

18. The method of claim 1, further comprising:
using the business intelligence model to filter and assemble results of performing the statistical analysis of the selected subset of data based at least in part on the selected one or more business intelligence factors,
wherein the output representing the statistical analysis of the selected subset of data comprises the filtered and assembled results.
